(19) United States
(12) Patent Application Publication
(10) Pub. No.: US 2007/0229407 A1
(43) Pub. Date: Oct. 4, 2007

(54) Display device

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/731,834

(22) Filed: Mar. 30, 2007

(30) Foreign Application Priority Data
Apr. 3, 2006 (KR) 10-2006-0030133

(51) Int. Cl. G09G 3/28

(52) U.S. Cl. 345/67

(57) ABSTRACT

Provided is a display device that performs addressing by discharging electrons and performs a sustain discharge according to gradation in an addressed discharge cell. The display device includes: first and second substrates facing each other; barrier ribs disposed between the first substrate and the second substrate and defining a plurality of discharge cells with the first and second substrates; first and second electrodes disposed in the barrier ribs; an electron emissive source formed on the second substrate and discharging a plurality of electrons into the discharge cells; a phosphor layer disposed in the discharge cells; and a gas stored in the discharge cells.

### CROSS-REFERENCE TO RELATED PATENT APPLICATION

This application claims the benefit of Korean Patent Application No. 10-2006-0030133, filed on Apr. 3, 2006 in the Korean Intellectual Property Office, the disclosure of which is incorporated herein in its entirety by reference.

### BACKGROUND OF THE INVENTION

1. Field of the Invention

The present embodiments relate to a display device that performs addressing by discharging electrons and performs a sustain discharge according to a gradation in the addressed discharge cells.

2. Description of the Related Art

Liquid crystal displays (LCDs), plasma display panels (PDPs), field emission displays (FEDs), etc. are display devices, and in particular, flat display devices.

LCDs, which are non-light emitting display devices and require a separate back light, are distinguished from PDPs and FEDs, which are light emitting display devices and do not require a separate back light.

PDPs form images using an electrical discharge, and have a good brightness and viewing angle, etc., and the use of PDPs has recently increased. PDPs display images using visible light emitted through a process of exciting a phosphor material with ultraviolet rays generated by a discharge of a discharge gas between electrodes when a direct current (DC) voltage or an alternating current (AC) voltage is applied to the electrodes.

In FEDs, electron emission devices electrically connected to a cathode electrode discharge electrons due to a difference between voltages applied to a gate electrode and the cathode electrode, respectively, discharged electrons collide with phosphor substances, and visible light is emitted.

To drive PDPs, a unit frame is divided into a plurality of sub fields to express gradation, and each sub field has an address period where a discharge cell is selected to be turned on and off from all the discharge cells and a sustain period where a sustain discharge is performed in discharge cells that are selected to be turned on according to a gradation allocated to each of the sub fields. In driving PDPS, an address discharge is performed to select a discharge cell to be turned on and off from all the discharge cells in the address periods of each sub field. However, since the address discharge is generally delayed in time, it is difficult to drive PDPs at high speed. Also, the address period of PDPs having high resolution increases to perform a stable address discharge, which reduces the sustain-discharge period.

To drive FEDs, pulse amplitude modulation (PAM) or pulse width modulation (PWM) is used to express gradation. In driving FEDs, electron emissive characteristics of electron emissive devices must be identical to each other to express desired gradation. However, the electron emissive characteristics of electron emissive devices are different from each other due to a process, which deteriorates uniformity in expressing brightness.

### SUMMARY OF THE INVENTION

The present embodiments provide a display device that can reduce a driving voltage and improve light-emitting efficiency.

According to an aspect of the present embodiments, there is provided a display device, comprising: first and second substrates facing each other; barrier ribs disposed between the first substrate and the second substrate and defining a plurality of discharge cells with the first and second substrates; first and second electrodes disposed in the barrier ribs; an electron emissive source formed on the second substrate and discharging a plurality of electrons into the discharge cells; a phosphor layer disposed in the discharge cells; and a gas stored in the discharge cells.

The electron emissive source may comprise: third electrodes disposed on the second substrate; an electron emissive device formed on the third electrodes; and fourth electrodes disposed on the third electrodes.

The electron emissive source further may comprise an insulation layer between the electron emissive device and the fourth electrodes.

A unit frame used to display an image may be divided into a plurality of sub fields, and each sub field has an address period where a discharge cell is selected to be turned on and off from all the discharge cells and a sustain period where a sustain discharge is performed in discharge cells that are selected to be turned on according to a gradation allocated to each of the sub fields.

In the address period, a scan pulse sequentially having a ground voltage or a negative voltage may be applied to the third electrodes, and a display data signal selectively having a positive voltage is applied to the fourth electrodes in accordance with the scan pulse.

In the sustain period, a sustain pulse having a high level and a low level may be alternately applied to the first electrodes and the second electrodes.

The sustain pulse having the high level and the low level may be applied to one of the first electrodes and the second electrodes, and an intermediate level between the high level and the low level of the sustain pulse is applied to the another electrodes.

In the sustain period, the gas may be excited due to a difference in electric potentials between the first electrodes and the second electrodes and the discharged electrons and ultraviolet rays are generated, the phosphor layer is excited due to the ultraviolet rays, and visible light is generated.

In the sustain period, the difference in electric potentials between the first electrodes and the second electrodes may be lower than a discharge start voltage.

The first electrodes and the second electrodes may be parallel to each other.

The third electrodes and the fourth electrodes may extend to cross each other.

The display device may further comprise: fifth electrodes disposed on the first substrate and collecting the discharge electrons.

The phosphor layer may be formed on the first substrate.

The display device may further comprise: a protective layer formed on the sidewalls of the barrier ribs.

The electron emissive device may be a carbon nanotube (CNT).

The electron emissive device may be formed of oxidized porous silicon (OPS).

### BRIEF DESCRIPTION OF THE DRAWINGS

The above and other features and advantages of the present embodiments will become more apparent by describing in detail exemplary embodiments thereof with reference to the attached drawings in which:

FIG. 1 is a cross-sectional view of a display device according to an embodiment;

FIG. 2 is a cross-sectional view of an electron emissive source of the display device illustrated in FIG. 1 according to an embodiment;

FIG. 3 is a cross-sectional view of an electron emissive source of the display device illustrated in FIG. 1 according to another embodiment;

FIG. 4 is a cross-sectional view of an electron emissive source of the display device illustrated in FIG. 1 according to another embodiment;

FIG. 5 illustrates an arrangement of electrodes of a display device according to an embodiment;

FIG. 6 is a timing diagram of driving signals applied to each of the electrodes illustrated in FIG. 5 according to an embodiment; and

FIG. 7 is a timing diagram of driving signals applied to each of the electrodes illustrated in FIG. 5 according to another embodiment.

### DETAILED DESCRIPTION OF THE INVENTION

The present embodiments will now be described more fully with reference to the accompanying drawings, in which exemplary embodiments are shown.

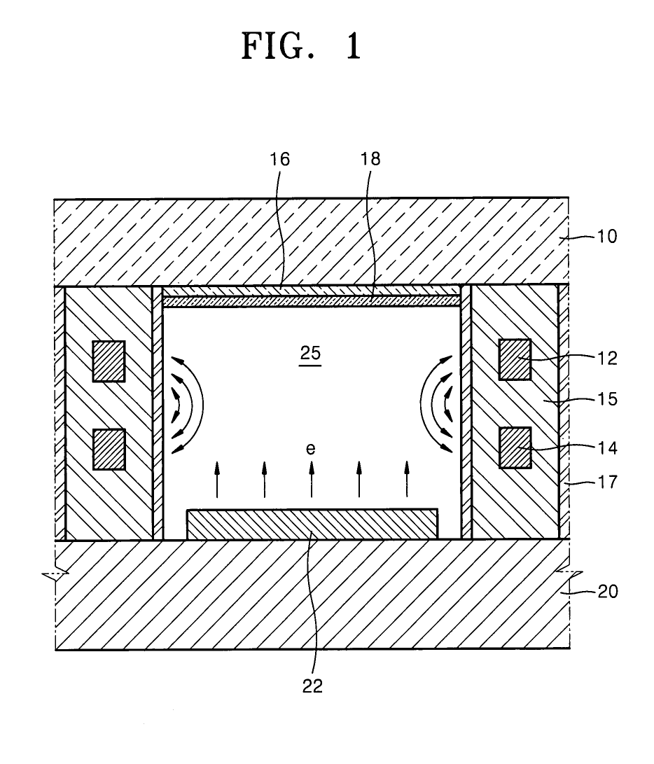

FIG. 1 is a cross-sectional view of a display device according to an embodiment.

Referring to FIG. 1, the display device of the current embodiment comprises a first substrate 10, a second substrate 20, an electron emissive source 22, barrier ribs 15, a first electrode 12, a second electrode 14, a phosphor layer 18, and a gas. The display device can further comprise a fifth electrode 16.

The first substrate 10 and the second substrate 20 are spaced apart from each other and face each other. The first substrate 10 and the second substrate 20 can be formed of a transparent material such as glass, but the present embodiments are not restricted thereto. The first substrate 10 and the second substrate 20 may be formed of the same material or a different material. In some embodiments, the first substrate 10 and the second substrate 20 have the same coefficient of thermal expansion.

The barrier ribs 15 can be integrally formed as shown, and be separately attached to the first substrate 10 and the second substrate 20 (a front barrier rib and a rear barrier rib). The barrier ribs 15 along with the first substrate 10 and the second substrate 20 define a discharge cell 25 in which a discharge is performed. The discharge cell 25 can be an aperture having a circular cross-section in the barrier ribs 15 but the present embodiments are not restricted thereto. The discharge cell 25 can have a hexagonal, octagonal, pentagonal, oval, etc. cross-section. The barrier ribs 15 partition the discharge cell 25 in the form of matrix but the present embodiments are not restricted thereto. The barrier ribs 15 can partition the discharge cell 25 in a variety of patterns such as waffle, delta, etc. as they can form a plurality of discharge spaces.

The first electrode 12 and the second electrode 14 are disposed in the barrier ribs 15. The first electrode 12 and the second electrode 14 may surround the discharge cells 25 forming the aperture having the circular cross-section, and extend in a direction.

A protective layer 17 formed of MgO, for example, may be formed on the sidewalls of the barrier ribs 15 that define the discharge cell 25. When a discharge is performed, the protective layer 17 protects the first electrode 12, the second electrode 14, and the barrier ribs 15 formed of a dielectric substance covering the first electrode 12 and the second electrode 14, and discharges secondary electrons to facilitate the discharge.

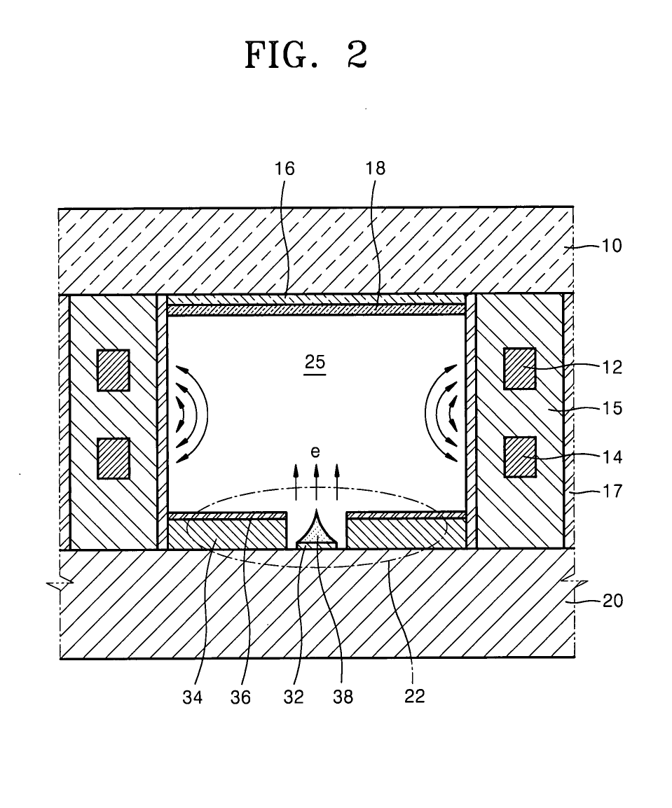

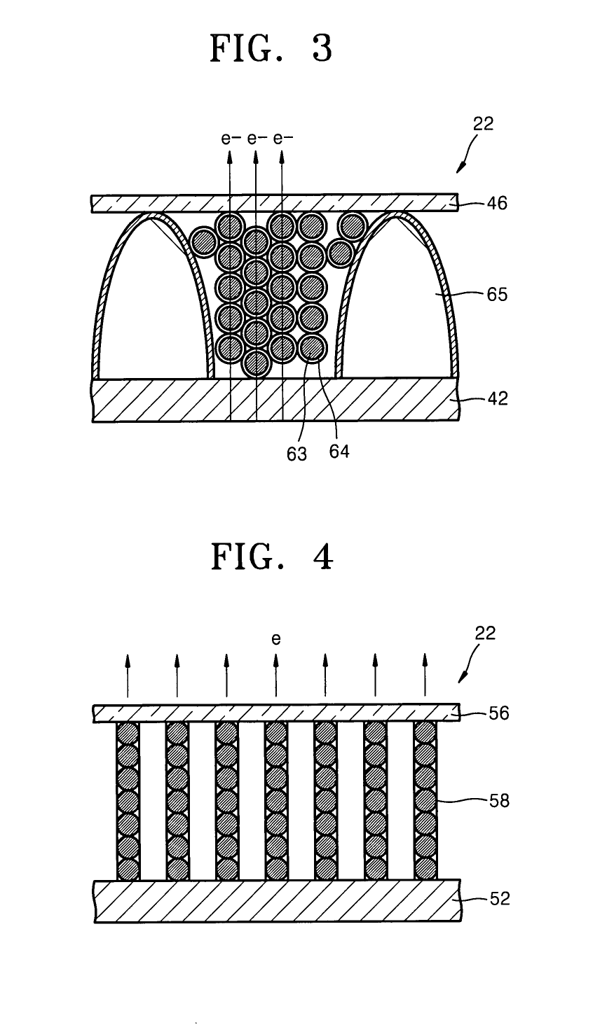

The electron emissive source 22 that discharges a plurality of electrons into the discharge cell 25 is disposed on the upper surface of the second substrate 20. The electron emissive source 22 comprises a third electrode (32 in FIG. 2, 42 in FIG. 3, and 52 in FIG. 4), an electron emissive device (38 in FIG. 2, 63 in FIG. 3, and 58 in FIG. 4) electrically connected to the third electrode, and a fourth electrode (36 in FIG. 2, 46 in FIG. 3, and 56 in FIG. 4) disposed on the upper parts of the third electrode and the electron emissive device. The electron emissive device can be formed of, for example, oxidized porous silicon (OPS). The OPS can be, for example, oxidized porous poly silicon (OPPS) or oxidized porous amorphous silicon (OPAS). The electron emissive device can be, for example, a carbon nanotube (CNT), and have a boron nitride bamboo shoot (BNBS) structure. However, the structure of the electron emissive device is not restricted thereto and can have various modifications.

The electron emissive device of the electron emissive source 22 uses a hot cathode or a cold cathode as an electron source. A field emitter array (FEA) type electron emissive device, a surface conduction emitter (SCE) type electron emissive device, a metal-insulator-metal (MIM) type electron emissive device, a metal-insulator-semiconductor (MIS) type electron emissive device, a ballistic electron surface emitting (BSE) type electron emissive device, etc. use the cold cathode as the electron source.

When the FEA type electron emissive device uses a material having a low work function or a high β function, the FEA type electron emissive device easily discharges electrons due to a difference between electric fields in vacuum and uses a tip structure having a sharp leading edge and a main material such as, for example, Mo or Si, a carbon-circle material such as graphite, diamond-like carbon (DLC), and the like, and a nanomaterial such as a nanotube or a nanowire.

The SCE type electron emissive device provides a conductive thin film between the third and fourth electrodes facing each other, and a hair crack to the conductive thin film to form the electron emissive source 22. A voltage is applied to the third and fourth electrodes, a current flows to the surface of the conductive thin film, and electrons are discharged from the electron emissive source which is the hair crack.

The MIM type and MIS type electron emissive devices form the electron emissive source 22 having a MIM structure and MIS structure, respectively, and discharge electrons by moving and accelerating the electrons from a metal or a semiconductor having a high electron potential to another metal having a low electron potential when a voltage is applied between two metals or the metal and the semiconductor, which are spaced apart from each other by a dielectric layer.

The BSE type electron emissive device forms an electron supply layer (corresponding to the electron emissive device) forming a metal or a semiconductor on an ohmic electrode, and an insulation layer and a metal thin film on the electron supply layer, and discharge electrons by applying power to the ohmic electrode and the metal thin film using the principle that if the size of a semiconductor is reduced to lower than a mean free path of electrons of the semiconductor, the electrons do not scatter but instead travel.

The phosphor layer 18 is formed on the first substrate 10. When the fifth electrode 16 that collects electrons discharged into the discharge cell 25 is disposed on the first substrate 10, the phosphor layer 18 can be formed on the fifth electrode 16 as illustrated in FIG. 1. Apart from FIG. 1, the fifth electrode 16 and the phosphor layer 18 can be disposed in a groove formed on the first substrate 10. Also, the phosphor layer 18 can cover the sidewalls of the barrier ribs 15. The location of the phosphor layer 18 is not restricted to that illustrated in FIG. 1.

A gas is charged in the discharge cell 25. The gas is used to perform a discharge in the discharge cell 25 and is hereinafter referred to as a discharge gas. The discharge gas can be a mixture with Xe gas at about 10% of the mixture, and one or more of Ne gas, He gas, and Ar gas each at about 10% of the mixture.

The barrier ribs 15 can be formed of a dielectric substance that prevents the first and second electrodes 12 and 14 from sending a current therebetween, and prevents the first and second electrodes 12 and 14 from being damaged due to collisions between charge particles and the first and second electrodes 12 and 14, thereby accumulating wall charges by inducing the charge particles. The dielectric substance may be, for example, PbO, B₂O₃, SiO₂, and the like.

Since a predetermined voltage is applied to the first and second electrodes 12 and 14, respectively, to perform the discharge, the first and second electrodes 12 and 14 may be formed of, for example, Ag, Cu, Cr, etc. or other materials having a high electric conductivity.

The phosphor layer 18 is formed by coating a phosphor paste that is a mixture of one of a red light emitting phosphor substance, a green light emitting phosphor substance, and a blue light emitting phosphor substance, a solvent, and a binder to the groove of the first substrate 10, and drying and baking the coated groove. The red light emitting phosphor substance can be, for example, Y(V,P)O₄:Eu, etc, the green light emitting phosphor substance can be, for example, Zn₂SiO₄:Mn, YBO₃:Tb, etc., and the blue light emitting phosphor substance can be, for example, BAM:Eu, etc.

A second protective layer (not shown) formed of, for example, MgO can be formed on the entire surface of the phosphor layer 18. When the discharge is performed in the discharge cell 25, the second protective layer prevents the phosphor layer 18 from being deteriorated due to collisions of discharge particles, and discharges secondary electrons to facilitate the discharge.

FIG. 2 is a cross-sectional view of the electron emissive source 22 of the display device illustrated in FIG. 1 according to an embodiment.

Referring to FIG. 2, the electron emissive source 22 is a FEA type electron emissive source. The electron emissive source 22 comprises the third electrode 32, the electron emissive device 38, the insulation layer 34, and the fourth electrode 36. The third electrode 32 is disposed on the second substrate 20. The electron emissive device 38 electrically connected to the third electrode 32 is disposed on the third electrode 32. The fourth electrode 36 is disposed on the upper part of the insulation layer 34 so that the fourth electrode 36 can be insulated from the third electrode 32 and the electron emissive device 38. In detail, the insulation layer 34 and the fourth electrode 36 are disposed on the second substrate 20 and a groove is formed in the second substrate 20, so that the third electrode 32 and the electron emissive device 38 are sequentially disposed therebetween. The electron emissive device 38 can be a Spindt type micro tip.

Since the third electrode 32 and the fourth electrode 36 perform addressing, they may extend to cross each other. The electron emissive device 38 discharges a plurality of electrons into the discharge cell 25 due to a difference between electric potentials applied to the third electrode 32 and the fourth electrode 36.

The third electrode 32 serves as a cathode electrode, and the fourth electrode 36 serves as a gate electrode, which is called an under-gate structure. Although not shown, another under-gate structure in which the cathode electrode and the electron emissive device 38 electrically connected to the cathode electrode can be disposed on the upper parts of the gate electrode and the insulation layer can be realized as the electron emissive source 22.

FIG. 3 is a cross-sectional view of an electron emissive source of the display device illustrated in FIG. 1 according to another embodiment.

Referring to FIG. 3, the electron emissive source of the current embodiment is a BSE type electron emissive source. The electron emissive source comprises the third electrode 42 and an electron supply layer formed on the third electrode 42, e.g., the electron emissive device 62, and the fourth electrode 46 disposed on the upper part of the electron emissive device 63.

More specifically, pillar-shaped polysilicon structures 65 are formed on the upper part of the third electrode 42, and porous nanocrystal structures 63 are disposed between the pillar-shaped polysilicons 65. The nanocrystal structures 63 can be formed of OPS. The OPS can be OPPS or OPAS. The fourth electrode 46 is formed on the nanocrystal structures 63. If a voltage having a predetermined difference between electric potentials is applied to the third electrode 42 and the fourth electrode 46, respectively, electrons entering into the nanocrystal structures 63 are accelerated without collisions and discharged into the discharge cell 25 (ballistic electron emission). The fourth electrode 46 may be formed of a thin film to discharge electrons.

FIG. 4 is a cross-sectional view of an electron emissive source of the display device illustrated in FIG. 1 according to another embodiment.

Referring to FIG. 4, a plurality of perpendicularly arranged carbon nanotubes 58 are disposed on the third electrode 52 as an electron emissive device, and the fourth electrode 56 is formed on the upper part of the carbon nanotubes 58. When the carbon nanotubes 58 are formed of a metal, an insulation layer (not shown) may be further formed on the surfaces of the carbon nanotubes 58 so that the carbon nanotubes 58 can be insulated from the fourth electrode 56. If a voltage having a predetermined difference between electric potentials is applied to the third electrode 52 and the fourth electrode 56, respectively, the carbon nanotubes 58 transfer ballistic electrons to discharge electrons into the discharge cell 25. The fourth electrode 56 may be formed of a thin film to discharge electrons.

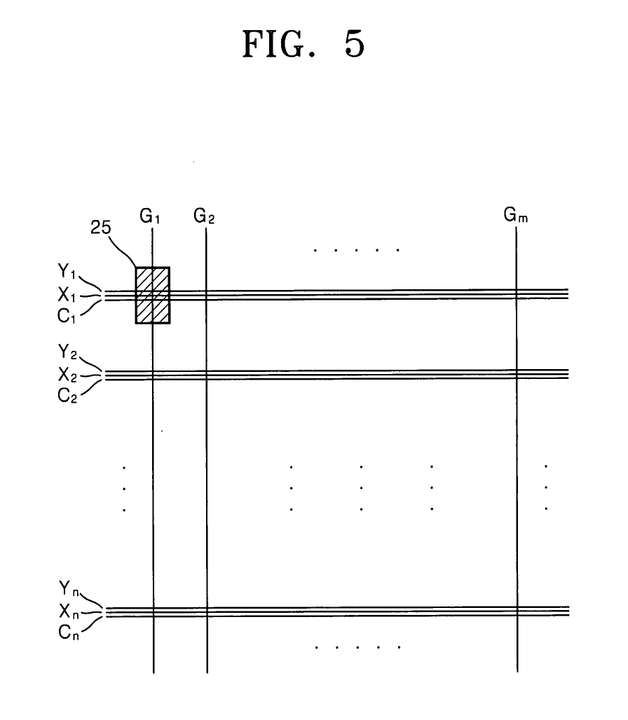

FIG. 5 illustrates an arrangement of electrodes of a display device according to an embodiment.

Referring to FIG. 5, the display device of the current embodiment comprises third electrodes and fourth electrodes that cross each other in an electron emissive source to perform addressing, and first electrodes and second electrodes in which a sustain discharge is performed in an addressed discharge cell.

Hereinafter, the first, second, third, and fourth electrodes are Y, X, C (cathode), and G (gate) electrodes, respectively. Since a sustain pulse may be applied to at least one of the Y and X electrodes to perform the sustain discharge, the Y electrodes Y₁ through Yₙ and the X electrodes X₁ through Xₙ are parallel to each other. Since a scan pulse is applied to the C electrodes C1 through Cn and a display data signal is applied to the G electrodes G₁ through Gₘ to perform addressing, the C electrodes C₁ through Cₙ may be parallel to the X electrodes X₁ through Xₙ and the Y electrodes Y₁ through Yₙ, and the G electrodes G₁ through Gₘ may extend to cross the X electrodes X₁ through Xₙ, the Y electrodes Y₁ through Yₙ, and the C electrodes C₁ through Cₙ. The X electrodes X₁ through Xₙ, the Y electrodes Y₁ through Yₙ, and the C electrodes C₁ through Cₙ are spaced apart from one another in order to express that the X electrodes X₁ through Xₙ, the Y electrodes Y₁ through Yₙ, and the C electrodes C₁ through Cₙ are disposed between the first substrate 10 and the second substrate 20. Apart from the drawing, the G electrodes G1 through Gm can be parallel to the X electrodes X₁ through Xₙ and the Y electrodes Y₁ through Yₙ, and the C electrodes C₁ through Cₙ can extend to cross the X electrodes X₁ through Xₙ and the Y electrodes Y₁ through Yₙ, and G electrodes G₁ through Gₘ.

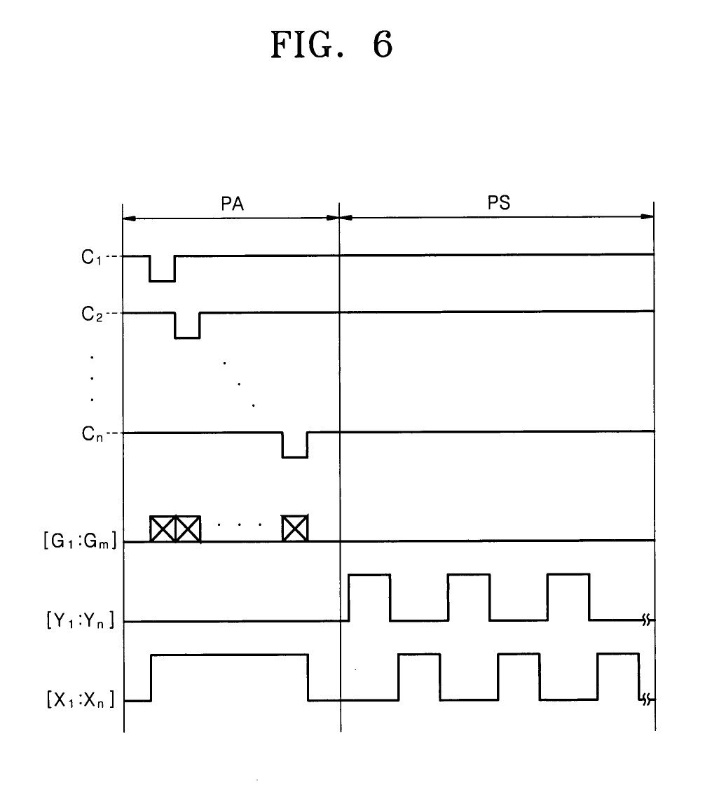

FIG. 6 is a timing diagram of driving signals applied to each of the electrodes illustrated in FIG. 5 according to an embodiment.

To drive the display device of the present embodiments, a unit frame (60 Hz under the national television system committee (NTSC) and 50 Hz under the phase alternation by line system (PAL)) to express an image is divided into a plurality of sub fields, and a gradation is allocated to each sub field. Each sub field is divided into an address period PA and a sustain period PS. In the address period PA, a discharge cell is selected to be turned on and off from all the discharge cells to express the gradation. In the sustain period PS, a sustain discharge is performed in discharge cells that are selected to be turned on according to a gradation allocated to each of the sub fields.

Referring to FIG. 6, in the address period PA, a scan pulse is sequentially applied to the C electrodes C₁ through Cₙ. The scan pulse sequentially having a high level and a low level is applied to the C electrodes C₁ through Cₙ. A display data signal used to select a discharge cell is applied to the G electrodes G₁ through Gₘ in accordance with the scan pulses. The display data signal has a positive address voltage. In detail, the display data signal has an address voltage having the high level when the discharge cell is selected, and an address voltage having the low level (a ground voltage) when the discharge cell is not selected. An electron emissive source of a discharge cell to be turned on discharges a plurality of electrons into the discharge cell due to the application of the scan pulse and the display data signal. Also, in the address period PA, a bias voltage is applied to the X electrodes X₁ through Xₙ to hold electrons as wall charges.

In the sustain period PS, a sustain pulse sequentially having a high level and a low level is applied to the Y electrodes Y₁ through Yₙ and the X electrodes X₁ through Xₙ. The length of the sustain pulse is determined according to the gradation weight. The gradation is expressed by performing a sustain discharge due to the electrons discharged in the address period PA and a difference in electric potentials between the Y electrodes Y₁ through Yₙ and the X electrodes X₁ through Xₙ. Although a difference in electric potentials between the high level and the low level of the sustain pulse, e.g., the difference in electric potentials between the Y electrodes Y₁ through Yₙ and the X electrodes X₁ through Xₙ, is smaller than a discharge start voltage, the sustain discharge is performed due to the electrons discharged into the discharge cell of the electron emissive source in the address period PA.

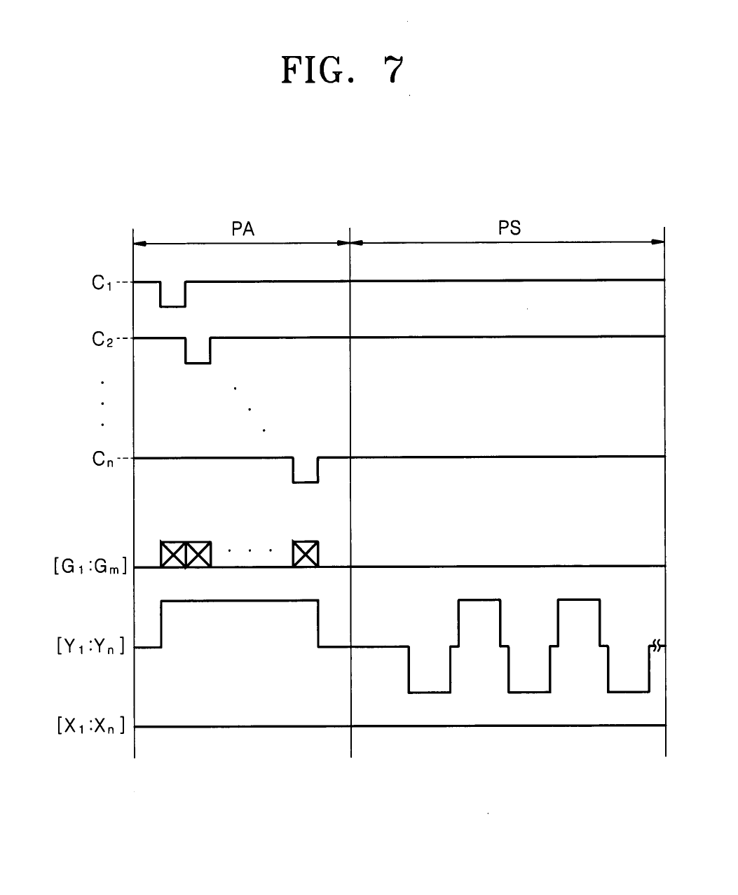

FIG. 7 is a timing diagram of driving signals applied to each of the electrodes illustrated in FIG. 5 according to another embodiment. In comparison with the previous embodiment of FIG. 6 and the current embodiment of FIG. 7, both embodiments are identical to each other except that different driving signals are applied to the Y electrodes Y₁ through Yₙ and the X electrodes X₁ through Xₙ in the sustain period PS and the bias voltage is applied to the Y electrodes Y₁ through Y₁ in the address period PA to hold electrons as wall charges.

Since it is sufficient that a predetermined difference in electric potentials between the Y electrodes Y₁ through Yₙ and the X electrodes X₁ through Xₙ is lower than the discharge start voltage to perform the sustain discharge, a sustain pulse sequentially having a high level and a low level is applied to the Y electrodes Y₁ through Yₙ. The sustain pulse may sequentially have a positive voltage and a negative voltage. An intermediate level of the high level and the low level of the sustain pulse applied to the Y electrodes Y₁ through Yₙ is applied to the X electrodes X₁ through Xₙ. That is, a ground voltage may be applied to the X electrodes X₁ through Xₙ.

Although not shown in FIGS. 7 and 8, when the display device is driven, it is possible to further perform a reset period where all the discharge cells are initialized before the address period PA of each sub field. A variety of driving signals can be applied in the reset period. For example, a reset pulse having a rising ramp and a falling ramp can be applied to the scan electrodes Y₁ through Yₙ. It is possible to use a selective reset method (application of a falling ramp pulse) of initializing a discharge cell in which the sustain discharge is performed in the sustain period of a previous sub field.

As described above, the display device of the present embodiments uses an electric field emissive principle to perform addressing, and applies a sustain pulse to perform a sustain discharge, it is possible to address problems of a brightness deterioration caused by non-uniform characteristics in a manufacturing process of an electron emissive source of a FED and an address discharge delay of the PDP. That is, an address period is reduced and brightness uniformity is improved regardless of the manufacturing process.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A display device, comprising:
first and second substrates facing each other;
barrier ribs disposed between the first substrate and the second substrate configured to define a plurality of discharge cells with the first and second substrates;
first and second electrodes disposed in the barrier ribs;
an electron emissive source formed on the second substrate configured to discharge a plurality of electrons into the discharge cells;
a phosphor layer disposed in the discharge cells; and
a gas in the discharge cells.

2. The display device of claim 1, wherein the electron emissive source comprises:
third electrodes disposed on the second substrate;
an electron emissive device formed on the third electrodes; and
fourth electrodes disposed on the third electrodes.

3. The display device of claim 2, wherein the electron emissive source further comprises an insulation layer between the electron emissive device and the fourth electrodes.

4. The display device of claim 2, wherein a unit frame configured to display an image is divided into a plurality of sub fields, wherein each sub field has an address period where a discharge cell is selected to be turned on and off from all the discharge cells and a sustain period where a sustain discharge is performed in discharge cells that are selected to be turned on according to a gradation allocated to each of the sub fields.

5. The display device of claim 4, wherein during the address period, a scan pulse sequentially having a ground voltage or a negative voltage is applied to the third electrodes, and a display data signal selectively having a positive voltage is applied to the fourth electrodes in accordance with the scan pulse.

6. The display device of claim 4, wherein during the sustain period, a sustain pulse having a high level and a low level is alternately applied to the first electrodes and the second electrodes.

7. The display device of claim 4, wherein the sustain pulse having the high level and the low level is applied to one of the first electrodes and the second electrodes, and an intermediate level between the high level and the low level of the sustain pulse is applied to the other electrodes.

8. The display device of claim 4, wherein during the sustain period, the gas is excited due to a difference in electric potentials between the first electrodes and the second electrodes, wherein discharged electrons and ultraviolet rays are generated, and wherein the phosphor layer is excited due to the ultraviolet rays, and visible light is generated.

9. The display device of claim 8, wherein during the sustain period, the difference in electric potentials between the first electrodes and the second electrodes is lower than a discharge start voltage.

10. The display device of claim 1, wherein the first electrodes and the second electrodes are parallel to each other.

11. The display device of claim 2, wherein the third electrodes and the fourth electrodes extend to cross each other.

12. The display device of claim 2, further comprising: fifth electrodes disposed on the first substrate configured to collect the discharge electrons.

13. The display device of claim 1, wherein the phosphor layer is formed on the first substrate.

14. The display device of claim 1, further comprising: a protective layer formed on the sidewalls of the barrier ribs.

15. The display device of claim 2, wherein the electron emissive device comprises a carbon nanotube (CNT).

16. The display device of claim 15, wherein the electron emissive device has a boron nitride bamboo shoot (BNBS) structure.

17. The display device of claim 2, wherein the electron emissive device comprises porous silicon (OPS).

18. The display device of claim 17, wherein the porous silicon is oxidized porous poly silicon (OPPS).

19. The display device of claim 17, wherein the porous silicon is oxidized porous amorphous silicon (OPAS).

20. The display device of claim 1, further comprising a protective layer formed on the sidewalls of the barrier ribs.
